(19) United States
(12) Patent Application Publication
(10) Pub. No.: US 2005/0129798 A1
(43) Pub. Date: Jun. 16, 2005

(54) Device and a process for producing blown films

(76) Inventor: Wolfram Littek, Solingen (DE)

Correspondence Address: LANXESS CORPORATION, 111 RIDC PARK WEST DRIVE, PITTSBURGH, PA, 15275-1112, US

(21) Appl. No.: 10/999,086

(22) Filed: Nov. 29, 2004

(30) Foreign Application Priority Data
Nov. 28, 2003 (DE) 10355809.8

(51) Int. Cl. B29C 47/20

(52) U.S. Cl. 425/326.1

(57) ABSTRACT

An apparatus and process for producing blown films is disclosed. The apparatus includes arranged in sequence an extruder equipped with an annular die, an annular cooling unit, a suction device and the flattening unit. In an additional embodiment of the invention a sizing unit is positioned between the cooling unit and the flattening unit. The apparatus is suitable for the preparation of blown films of improved quality.

### FIELD OF THE INVENTION

The invention concerns a device and process for the manufacture of plastic films, and more particularly blown films.

### BACKGROUND OF THE INVENTION

The production of blown films is well known. In principle, a hot plastic melt which emerges from an extruder is extruded substantially vertically upwards through an annular die to give a tubular film, optionally via a deflection head. On emerging from the die, the film tube is blown out to the required external diameter with air which is blown into the interior of the film tube, wherein the required film thickness is adjusted as a function of the chosen take-off speed. The blown film is supported and stabilized with the aid of a sizing cage which surrounds the film tube. At the same time, the film tube is cooled from outside and/or from inside with the aid of air. The cooled film tube is then collapsed to yield a flat film with the aid of a flattening unit, e.g. a pair of rolls.

Processes for producing such blown films are disclosed for example in J. Nentwig, Kunststoff-Folien, Herstellung-Eigenschaften-Anwendung, 2nd revised edition, Carl Hanser Verlag München Wien, 2000, Chapter 3.2.6 Blasfolien, pages 53-56 and in O. E. Ahlhaus, Verpackung mit Kunststoffen, Carl Hanser Verlag München Wien, 1997, Chapter 6.1.1 Herstellungsverfahren für Verpackungsfolien, pages 110-113.

The inventors of the present invention recognized that there is the problem that volatile components, e.g. monomers, oligomeric, additives, degradation products and the like, are emitted from the hot plastic melt which emerges from the die. Depending on which particular volatile components are emitted, these gases, vapors, aerosols or the like lead to problems with smell or even to pollution by hazardous substances in the environment of the blown film plant. In addition, the emitted substances may settle out onto components of the blown film plant, such as, but not limited to, the sizing cage. These deposits require special cleaning of the plant and cause increased maintenance costs. There again, particles of the deposits may fall down onto the film which impairs the film quality and optionally the winding quality of the (film) roll.

### SUMMARY OF THE INVENTION

An apparatus for producing blown films is disclosed. The apparatus includes arranged in sequence an extruder equipped with an annular die, an annular cooling unit, a suction device and the flattening unit. In an additional embodiment of the invention a sizing unit is positioned between the cooling unit and the flattening unit. The apparatus is suitable for the preparation of blown films of improved quality.

One aspect of the present invention is to provide a device and a process for producing blown films in which the emissions of volatile components from the plastic melts do not lead to deposits caused by condensation on components of the blown film plant.

The aspect is achieved by a device in which the emissions are extracted after emergence of the film tube from the die, with the aid of a suction device.

### BRIEF DESCRIPTION OF THE DRAWING

FIG. 1 is a schematic diagram of the inventive device for producing blown films.

### DETAILED DESCRIPTION OF THE INVENTION

Accordingly, the invention provides a device for producing blown films, comprising an extruder that is equipped at its exit with an annular die, a collapsing unit located either above or below the die and an annular cooling unit positioned between the die and the collapsing unit, and a suction device positioned between the die and the collapsing unit.

The suction device which, according to the invention, extracts volatile components emitted from the plastic melt may be integrated into the devices for producing blown films. The device according to the invention includes an extruder from which a hot plastic melt emerges during operation. The plastic melt exits the extruder through an annular die to produce a film tube. Generally, the extruder is arranged horizontally. At first the melt leaves the extruder and is then turned upwards as a compact stream before it is turned into foil tube or a melt tube that is released through a nozzle. Alternatively, the film tube may be extruded substantially vertically downwards. Unless stated otherwise, the expressions “above” and “below” used in the following refer to a device in which the film tube is extruded upwards, whereas the corresponding inverse structure then applies to a device with downwards extrusion.

Air is blown into the film tube in order to bring the film to the desired width and, depending on the chosen take-off speed, to the desired thickness.

Low molecular weight volatile components escape preferentially in regions of the film tube with high surface temperatures, i.e. emissions are observed in particular in regions close to the die. The volatile components may be monomers, oligomers, additives, solvents, degradation products and the like.

According to the invention, the suction device is positioned between the die and the flattening unit with which the film tube is folded up. If the film tube is extruded and taken off from the flattening unit substantially vertically upwards, then the suction device is located above the die and below the flattening unit. If, in the alternative structural form of the blown film plant the film tube is extruded and taken off substantially vertically downwards, then the suction device is located below the die and above the flattening unit.

The suction device is positioned in such a way that only small or negligible amounts of volatile components still escape above the suction device due to the temperature of the film. The suction device is also positioned so that the gases, vapors, aerosols or the like which are rising upwards are extracted before they may settle out onto components of the device such as e.g. the cooling unit or the optional sizing unit.

The device according to the invention for producing blown films (also referred to as blown film plant in the following) has, as is known in the art, an annular cooling unit between the die and the flattening unit. The cooling unit (or cooling device) is preferably located near the die. If the film tube moves upwards, the cooling device is located above the die and below the flattening unit. By using the cooling unit in the form of a cooling ring, cold air is blown against the film tube uniformly along the circumference. The cold air flowing upwards transports the emissions upwards.

The suction device is preferably located between the cooling unit and the flattening unit. In the case of an upwards operating structure for the device, this means that the suction device is located above the cooling unit. Optionally, a further cooling device may be located above the suction device, i.e. between the suction device and the flattening unit. Several more cooling units may also be present.

Cooling units with variable diameter are known in the art. These enable the diameter of the cooling unit to be adapted to the diameter of the film tube.

The device according to the invention preferably has a sizing unit positioned between the cooling unit and the flattening unit, in particular between the suction device and the flattening unit. Thus, a sizing unit is generally located above the cooling unit. Accordingly, the suction device in an upwards operating structure for the blown film line is preferably found above the cooling unit and below the sizing unit. The sizing unit is used to stabilize the film. Suitable sizing units include, in a simple design, several strips, arranged in the shape of a polygon, which restrict the external diameter of the tube. A better effect is achieved by arranging several of these polygons spaced one above the other. A further improvement in sizing is achieved by replacing the strips by rod-shaped elements which reduce the friction between the film tube and the sizing unit. This may take place with the aid of brushes or rollers. For better adaptation to the particular blown diameter of the tube, such strips or rod-shaped elements are arc-shaped and not straight and are mounted in a mutually adjustable manner inside a common frame by mechanical means e.g. a chain drive.

When the film tube has cooled sufficiently, it passes into a flattening unit above the sizing unit, in the device according to the invention. With the aid of the flattening unit, the film tube is folded to give a flat double, that is two-layered, film, if required also with further inserted folds or the like. The flattening unit may comprise, for example, a pair of rollers. In addition, two plate-shaped elements below a pair of rollers, these being arranged in the form of a wedge, may also be used to flatten the film tube. These plate-shaped elements may be designed, for example, as single plates, grids of rods, rolling belts, sheets or perforated and/or cooled sheets.

The suction device which extracts volatile components in the device according to the invention is preferably located above the cooling unit and below the sizing unit. The suction device preferably encloses the film tube in the form of a ring. Alternatively, the suction device may surround the film bubble in any geometry at all, e.g. square, oval. For this purpose, the suction device has an opening through which the film tube is passed. The diameter of this opening is preferably chosen so that the suction device does not come in contact with the film tube and too much friction between the suction device and the film bubble is avoided. The opening in the suction device preferably has a variable diameter which may be adjusted, depending on the diameter of the film tube. This may be achieved, for example, using the principle of an iris diaphragm, wherein one or more iris diaphragms determine the diameter of the opening. Thus, for example, both the lower end of the annular suction device, i.e. that turned towards the die, and also the upper boundary, i.e. that turned towards the flattening unit, may be provided with an iris diaphragm, the diameters of which may be adjusted either independently or together.

In an alternative embodiment, the diameter of the opening may also be adjustable, due to the fact that the suction device has several components which have different sizes and which are exchangeable so that the component of the required size may be chosen, depending on the desired diameter. Thus, for example, the suction device may contain several arc-shaped components for example, but not limited to concave-shaped, which surround the film tube in the form of a ring when put together.

The suction device may also be designed in the same way as a cooling ring known to one skilled in the art. Such a suction device is operated by using a reduced pressure instead of an increased pressure by extracting air instead of blowing air in.

Within the suction device, devices may be installed which ensure uniform flow of the mixture of air and emissions being extracted along the circumference. Thus, for each part of the circumference the same amount of air may be blown.

The suction device is provided with at least one hose or pipeline for extracting the emissions. The suction device is preferably provided with heatable inlet and outlet pipes in order to avoid condensation or settling out of the emissions in the inlet and outlet pipes. In addition, a cold trap for controlled condensation of the emissions is preferably provided in the suction device.

The suction device enables the extraction of low molecular weight volatile components which escape from the film tube. This prevents the emissions settling out on components of the blown film plant, such as e.g. the sizing unit.

Contamination of the blown film plant is thus minimized. In addition, no particles of condensed emissions may fall onto the film, wherein the quality of the film is preserved.

The invention also provides a process for producing blown film, using the device according to the invention.

With the aid of the inventive device and process films e.g. of polyamide and polyolefins, e.g. polyethylene, may be produced. The films may be monolayered or multilayered.

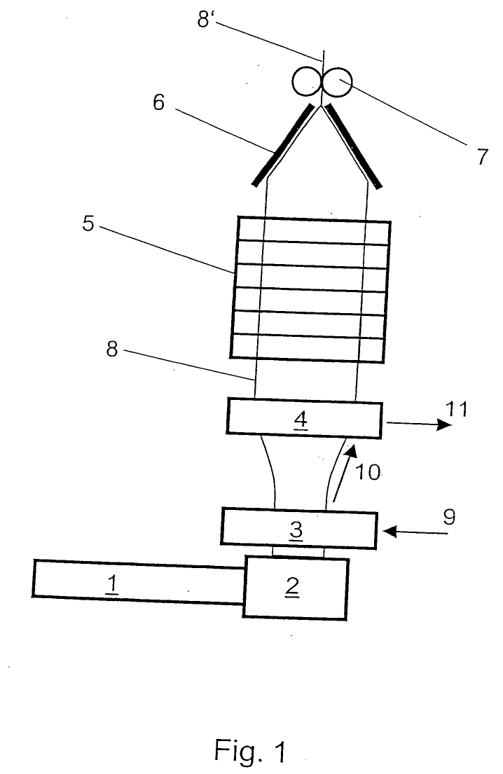

In the following, the invention is explained in more detail by making reference to the attached figure. FIG. 1 shows a schematic diagram of a device according to the invention for producing blown films. An extruder 1 is equipped with a die 2 from which the plastic melt emerges with the form of a film tube 8. Thus, the forming of the film tube may already take place in the nozzle, such that the melt leaves as a film tube. The film tube 8 shown emerges in a substantially vertically upwards direction. The two functions, i.e. turning the plastic melt from the horizontal to the vertical and extruding the film tube by means of an annular die, may be integrated into a single step or may be performed in two separate steps in the blown film plant. In the embodiment shown, both turning and extruding take place in a single component, the film blowing die.

Positioned above the die 2 is a cooling unit 3 in the form of a cooling ring. Cold air 9 is blown from outside onto the film tube (also referred to as film bubble) 8 with the aid of the cooling ring 3. The upwards flowing cold air 10 transports emissions from the film tube 8 in the direction of the suction device 4. The suction device 4 extracts the emissions 11. Above the suction device 4 there is positioned a sizing unit 5. This stabilizes the blown film bubble 8. Above the sizing unit 5 is a collapsing frame that includes a pair of plates 6 arranged in the form of a wedge and a pair of rollers 7, through which passes the largely cooled film tube 8. The collapsing frame folds up the film tube 8 to give a flat film 8′.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

1. An apparatus for producing blown films, comprising an extruder equipped with an annular die, an annular cooling unit, a suction device and a collapsing unit.

2. The apparatus according to claim 1, further comprising a sizing unit positioned between the annular cooling unit and the collapsing unit.

3. The apparatus according to claim 2, wherein the suction device is positioned between the annular cooling unit and the sizing unit.

4. The apparatus according to claim 1, wherein the suction device is annular.

5. The apparatus according to claim 4, wherein the annular suction device has an adjustable diameter.

6. A process for producing blown films comprising using the apparatus of claim 1.
